(19) United States
(12) Patent Application Publication
(10) Pub. No.: US 2004/0045004 A1
(43) Pub. Date: Mar. 4, 2004

(54) System for runtime web service to java translation

(76) Inventor: Manoj Cheenath, Alameda, CA (US)

Correspondence Address: Sheldon R. Meyer, Esq., FLIESLER DUBB MEYER & LOVEJOY LLP, Fourth Floor, Four Embarcadero Center, San Francisco, CA, 94111-4156, US

(21) Appl. No.: 10/337,752

(22) Filed: Jan. 7, 2003

Related U.S. Application Data
(60) Provisional application No. 60/406,786, filed on Aug. 29, 2002.

(51) Int. Cl. G06F 9/44; G06F 15/16

(52) U.S. Cl. 719/310

(57) ABSTRACT

The present invention provides a system for invoking web services among distributed applications that span diverse hardware and software platforms. A remote web service invocation system in accordance with one embodiment of the present invention consists of an implementation of the web service hosted by a server on the web, a standardized way to transmit data and web service invocation calls, and a standard way to describe the web service to clients so they can invoke the web service. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java communication commands and java programming objects.

### CROSS REFERENCE TO RELATED APPLICATIONS

The present application is related to the following United States patents and patent applications, which patents/applications are assigned to the owner of the present invention, and which patents/applications are incorporated by reference herein in their entirety:

United States patent application entitled “System for Web Service Generation and Brokering”, patent application Ser. No. ______, filed on Jan. 7, 2003, currently pending, which claims benefit to provisional patent application entitled “System for Web Service Generation and Brokering”, Application No. 60/406,798 filed on Aug. 29, 2002.

### FIELD OF THE INVENTION

This invention relates generally to the field of web services, and more particularly to dynamically invoking web services from heterogeneous environments.

### BACKGROUND OF THE INVENTION

Web services are a type of service shared by and used as components of distributed web-based applications. They commonly interface with existing back-end applications, such as customer relationship management systems, order-processing systems, and so on. Traditionally, software application architecture tended to fall into two categories: huge monolithic systems running on mainframes or client-server applications running on desktops. Although these architectures work well for the purpose of the applications they were built to address, they are relatively closed to the outside world and can not be easily accessed by the diverse users of the web.

The software industry is now evolving toward loosely coupled service-oriented applications that dynamically interact over the Web. The applications break down the larger software system into smaller modular components, or shared services. These services can reside on different computers and can be implemented by vastly different technologies, but they are packaged and transported using standard Web protocols, such as XML and HTTP, thus making them easily accessible by any user on the Web.

The concept of web services is not new—RMI, COM, and CORBA are all service-oriented technologies. However, applications based on these technologies require them to be written using a particular technology, often from a particular vendor. This requirement typically hinders widespread acceptance of an application on the Web. Further, web service invocation currently requires code generation to be done by a user. For applications written using a different technology, extra code must be provided to achieve compatibility between applications. The extra code, accompanied by the required code compiling, consumes valuable programmer time and resources. What is needed is a more efficient method of invoking heterogenous web services. The web service invoking system should be capable of invoking web services that span diverse hardware and software platforms.

### SUMMARY OF THE INVENTION

The present invention provides a system for invoking web services among distributed applications that span diverse hardware and software platforms. A remote web service invocation system in accordance with one embodiment of the present invention consists of an implementation of the web service hosted by a server on the web, a standardized way to transmit data and web service invocation calls, and a standard way to describe the web service to clients so they can invoke the web service. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java-based communication and java programming objects.

### BRIEF DESCRIPTION OF THE DRAWINGS

FIG. 1 is a diagram of a system for invoking a web service in accordance with one embodiment of the present invention.

FIG. 2 is a flow chart showing a method for invoking a remote web site in accordance with one embodiment of the present invention.

FIG. 3 is a flow chart showing a method for automatically generating a SOAP envelope in accordance with one embodiment of the present invention.

### DETAILED DESCRIPTION

To solve the problems and shortcomings of the prior art, the present invention provides a system for invoking web services among distributed applications that span diverse hardware and software platforms. In one embodiment of the present invention, web services are accessed using standard Web protocols such as XML and HTTP. Thus, the diverse and heterogeneous applications on the web can automatically access web services, solving the problem of how different systems communicate with each other. These different systems might be Microsoft SOAP ToolKit clients, J2EE applications, legacy applications, and so on. These systems might be written in a variety of programming languages, such as Java, C++, or Perl. As long as the application that provides the functionality is packaged as a web service each of these systems can communicate with any other system. In one embodiment of the present invention, the communication between servers and functionality of the servers is implemented in java.

A remote web service invocation system in accordance with one embodiment of the present invention consists of an implementation of the web service hosted by a server on the Web, a standardized way to transmit data and web service invocation calls, and a standard way to describe the web service to clients so they can invoke the web service. In one embodiment, web services are hosted by a server, are implemented using standard J2EE components such as Enterprise Java Beans and JMS, and are packaged as standard J2EE Enterprise Applications. A standardized way to transmit data and web service invocation calls between the web service and the user of the web service is implemented using Simple Object Access Protocol (SOAP) as the message format and HTTP as the connection protocol. The standard for describing the web service to clients is implemented as Web Services Description Language (WSDL).

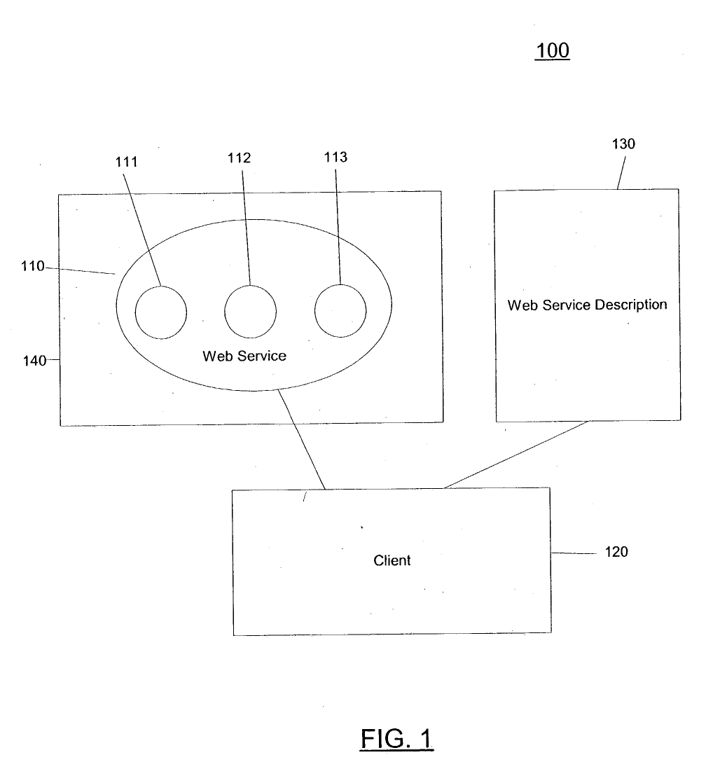

FIG. 1 shows a diagram of a web service invoking system 100 in accordance with one embodiment of the present invention. System 100 includes a web service 110, a client 120, and web service description file 130. The web service 110 includes methods 111, 112, and 113, and may be located on server 140. The web service 110 corresponds to the web service description file 130. The client may communicate with both the web service and the web service description file. The web service description file 130 may be located on server 140, or at a location separate from server 140, such as a separate server (not shown). The client may be an application running on a server, a remote computer, or any other type of system that may need to invoke a remote web service.

In one embodiment, the web service description file 130 is a WSDL file. WSDL is an XML based specification or format that describes a web service by describing the methods provided by a web service, input and output parameters of the service, and how to use the service. In one embodiment of the present invention, the web service invoking system automatically provides the WSDL file for a web service. In FIG. 1, the web service description 130 describes corresponding web service 110.

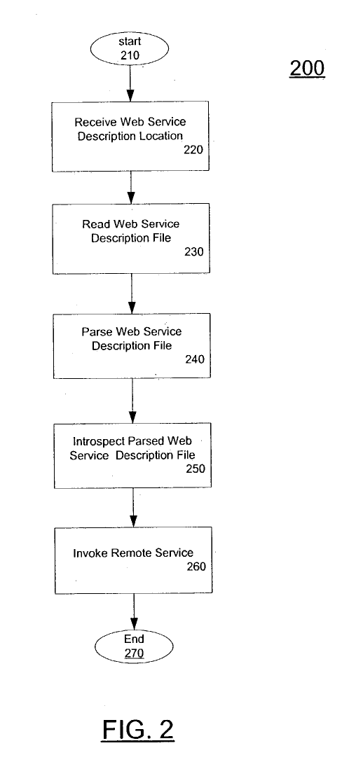

A method 200 for dynamic invocation of a web service in accordance with one embodiment of the present invention is shown in FIG. 2. The method begins with start operation 210. Next, the location of a web service description is provided in operation 220. In one embodiment, the web service description is a WSDL file located at a URL address. The URL of the WSDL file may be provided by a user or some other means. After the web service description location is provided, the web service description is read by the client in operation 230. Reading the WSDL file requires that the client connect to the server hosting the WSDL file. In one embodiment of the present invention, the client connects to the server by generating a URL connection with the server. The URL connection may be implemented in java using a URLConnection( ) command or in some other manner. Once the client has connected to the server, the client retrieves the document from the server. In one embodiment, the client retrieves the document by generating an input stream flowing from the server to the client. In one embodiment, the input stream is implemented in java using an InputStream command or by some other means. The WSDL file is then retrieved by the client through the input stream created by the java input stream command. An example of a WSDL file in accordance with one embodiment of the present invention is shown below:

<?xml version=“1.0”?>
<definitions name=“StockQuote”
targetNamespace=“http://example.com/stockquote.wsdl”

xmlns:tns=“http://example.com/stockquote.wsdl”
xmlns:xsd1=“http://example.com/stockquote.xsd”
xmlns:soap=“http://schemas.xmlsoap.org/wsdl/soap/”
xmlns:“http://schemas.xmlsoap.org/wsdl/”>

<types>

<schema targetNamespace=“http://example.com/stockquote.xsd”

xmlns=“http://www.w3.org/2000/10/XMLSchema”>

<element name=“TradePriceRequest”>

<complexType>

<all>

<element name=“tickerSymbol” type=“string”/>

</all>

</complexType>

</element>
<element name=“TradePrice”>

<complexType>

<all>

<element name=“price” type=“float”/>

</all>

</complexType>

</element>

</schema>

</types>
<message name=“GetLastTradePriceInput”>

<part name=“body” element=“xsd1:TradePriceRequest”/>

</message>
<message name=“GetLastTradePriceOutput”>

<part name=“body” element=“xsd1:TradePrice”/>

</message>
<portType name=“StockQuotePortType”>

<operation name=“GetLastTradePrice”>

<input message=“tns:GetLastTradePriceInput”/>
<output message=“tns:GetLastTradePriceOutput”/>

</operation>

</portType>
<binding name=“StockQuoteSoapBinding” type=“tns:StockQuotePortType”>

<soap:binding style=“document”

transport=“http://schemas.xmlsoap.org/soap/http”/>

<operation name=“GetLastTradePrice”>

<soap:operation soapAction=“http://example.com/GetLastTradePrice”/>
<input>

<soap:body use=“literal”/>

</input>
<output>

<soap:body use=“literal”/>

</output>

</operation>

</binding>
<service name=“StockQuoteService”>

<documentation>My first service</documentation>
<port name=“StockQuotePort” binding=“tns:StockQuoteBinding”>

<soap:address location=“http://example.com/stockquote”/>

</port>

</service>

</definitions>

Once a WSDL file is retrieved in step 230, the WSDL file is parsed in step 240. In one embodiment, the WSDL file is parsed by a java implemented parsing tool at runtime. The parsing tool acts as a pull-XML parser application program interface (API) to parse the WSDL input stream for WSDL messages and place the messages in memory. In one embodiment, the parsed WSDL file messages are placed into an internal data structure in memory. The internal data structure is a java representation of the WSDL file stored in memory. An example of a pseudo representation of the internal data structure in accordance with one embodiment of the present invention is shown below.

class Definition{

String name;
String targetNamespace;
Message [ ] messages;
PortType [ ] portTypes;
Binding [ ] bindings;
Service [ ] services;
}
class Message{
String name;
Part [ ] parts;
}
class Part{
String name;
String namespace;
Class javaType;
}
class PortType{
String name;
Operation [ ] operations;
}
class Operation{
String name;
Input input;
Output output;
Fault [ ] faults;
}
class Input{
String message;
}
class Output{
String message;
}
class Fault{
String message;
}
class Binding{
String name;
String type;
BindingOperation [ ] operations;
}
class BindingOperation{
String name;
String soapAction;
String targetNS;
String encodingStyle;
}
class Service{
String name;
Port [ ] ports;
}
class Port{
String name;
String binding;
String location;
}

After parsing the WSDL file into an internal data structure, the internal data structure is introspected in step 250. In one embodiment, introspecting is performed by a java API with a run-time table. The introspecting java API operates in a manner similar to java reflection APIs. In one embodiment, the java API lists the methods supported by the particular WSDL service and finds the number and type of parameters and return type for each method. The parsed messages are then mapped to java methods. The information may also be manipulated for purposes such as showing all the methods supported by a web service and finding a particular method of a web service. The java methods corresponding to the parsed messages may already be in the memory of the client or retrieved by the client after parsing.

Once the parsed WSDL file is introspected, the remote web service may be invoked in step 260. Information required to invoke a website may include a target URL, name of a method, and value of the parameters. The required information may be encoded as XML or in some other format suitable for processing over a network such as the Internet. In one embodiment of the present invention, the required information for invoking a web service is passed in a SOAP formatted envelope.

SOAP is a lightweight XML-based protocol used to exchange information in a decentralized, distributed environment. The protocol consists of an envelope, a set of encoding rules, and a convention for representing remote procedure calls. The envelope describes the SOAP message. In particular, the envelope contains the body of the message, identifies who should process it, and describes how to process it. The set of encoding rules expresses instances of application-specific data types.

The convention represents remote procedure calls and responses. This information is embedded in a Multipurpose Internet Mail Extensions.(MIME)-encoded package that can be transmitted over HTTP or other Web protocols. MIME is a specification for formatting non-ASCII messages so that they can be sent over the Internet.

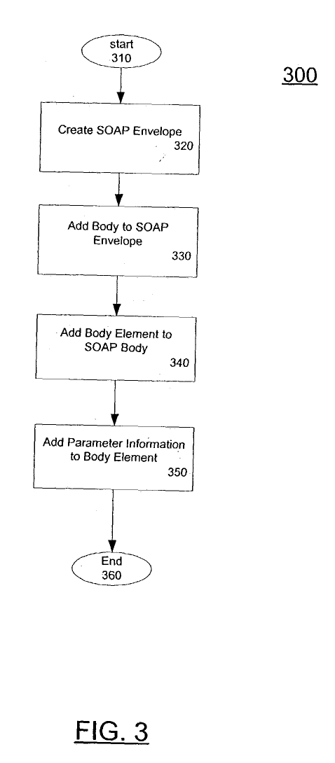

In one embodiment of the present invention, the remote web service invoking system automatically constructs a SOAP envelope for invoking a remote web service. A method 300 for automatically generating a SOAP envelope in accordance with one embodiment of the present invention is shown in FIG. 3. First, a SOAP envelope is created in step 310. Next, a body is added to the SOAP envelope in step 330. Then, a SOAP body element is added to the SOAP body in step 340. In one embodiment, the name of the body element will be the name of the method. Next, parameter information is added to the SOAP body element in step 350. In one embodiment, parameters or arguments needed to invoke the desired method are converted to XML before being added to the SOAP body element. For example, a “setAddress” method may take the three parameters name, street, and zip. Once the parameters have been added to the body element, SOAP envelope generation is complete and the process ends in step 360. In one embodiment, a java method signature for the method having parameters of name, street, and zip may look like this:

void setAddress (String name, String street, int zip).

An example of a SOAP envelope for the corresponding “setAddress” method is shown below.

<env:Envelope . . . >

<env:Body>

<m:setAddress xmlns:m=“http://myurl”>

<name>joe</name>
<street>north first street</street>
<zip>63844</zip>

<m:setAddress>

</env:Body>

</env:Envelope>

In one embodiment of the present invention, the web services are implemented as remote procedure call (RPC) web services. An RPC style web service is implemented using a stateless session EJB. The RPC style web service appears as a remote object to the client application. The interaction between a client and an RPC-style web service centers around a service-specific interface. When a client invokes a web service, the client sends the method name and parameter values to the web service. The web service then executes the required methods and then transmits the return values back to the client. RPC-style web services are synchronous, in that when a client sends a request, it waits for a response before doing anything else.

The XML encoded parameters for an RPC web service are placed inside a SOAP envelope and sent to the web service as an HTTP post request. In one embodiment, the web service may have a result or output after receiving the post request. In this case, the result of the HTTP post request is received by the client as an HTTP response wrapped in a SOAP envelope. The response SOAP envelope is then parsed to retrieve the response from the web service.

The system for invoking a remote web service in accordance with the present invention does not require the client or user to generate any code. The WSDL file corresponding to a web service to be invoked is retrieved, processed, and then used to invoke the web service. This is advantageous in that no code needs to be generated to invoke the web service, nor is any code compiling required. This saves valuable user time and processing. Instead of generating and compiling code, a run-time table is used to introspect the parsed web service information.

The present invention provides a system for invoking web services among distributed applications that span diverse hardware and software platforms. A remote web service invocation system in accordance with one embodiment of the present invention consists of an implementation of the web service hosted by a server on the web, a standardized way to transmit data and web service invocation calls, and a standard way to describe the web service to clients so they can invoke the web service. In one embodiment of the present invention, web services are accessed using standard web protocols such as XML and HTTP. The application that provides the functionality is packaged as a web service allowing each system to communicate with any other system. In one embodiment of the present invention, the invention is implemented in java using java programming objects.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing at least one of additive model representation and reconstruction.

Included in the programming (software) of the general/specialized computer or microprocessor are software modules for implementing the teachings of the present invention, including, but not limited to, separating planes of a source image, averaging at least one of foreground and background colors, replacing colors, and compensating for error introduced by color replacement in one plane by feeding error into a second plane, storage, communication of results, and reconstructing an image according to the processes of the present invention.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In the claims:

1. A system for invoking a remote web service comprising:
a remote web service having a method, the method having a parameter;
a web service description describing said remote web service; and
a client having a processor and a memory and configured to communicate with said remote web service and web service description, the client configured to retrieve the web service description,
process the web service description, and invoke the remote web service.

2. The system of claim 1 wherein the web service description is a WSDL file.

3. The system of claim 1 wherein the client is configured to retrieve the web service description using a java command.

4. The system of claim 1 wherein the client is configured to generate an internal data structure and store the internal data structure in the memory, the internal data structure corresponding to a java representation of said web service description.

5. The system of claim 1 wherein the client is configured to generate a message, the message configured to be sent to and invoke the remote web service.

6. The system of claim 5 wherein the message is a SOAP envelope.

7. The system of claim 6 wherein the SOAP envelope is automatically created from the retrieved web service description.

8. A system for remotely invoking web services comprising:
a plurality of web services, wherein at least one web service is maintained on a different software or hardware platform than at least one other web service;
a plurality of web service descriptions, wherein one web service description corresponds to each web service; and
a client configured to remotely invoke each of said plurality of web services by processing the web service description corresponding to the web service to be invoked.

9. The system of claim 8 wherein each of said plurality of web service descriptions is a WSDL file.

10. The system of claim 8 wherein the client is configured to retrieve each of said plurality of web service descriptions using a java command.

11. The system of claim 8 wherein the client is configured to generate an internal data structure and store the internal data structure in the memory, the internal data structure corresponding to a java representation of the one of said web service descriptions being processed.

12. The system of claim 8 wherein the client is configured to generate a message, the message configured to be sent to and invoke one of said plurality of remote web services.

13. The system of claim 12 wherein the message is a SOAP envelope.

14. The system of claim 13 wherein the SOAP envelope is automatically created from the retrieved web service description.

15. A system for invoking a remote web service comprising:
a remote web service having a method, the method having a parameter;
a web service description describing said remote web service, the web service description having a message; and
a client having:
a processor;
a memory;
an input means; and
an output means, the client configured to receive the web service description using the input means, process the web service description with the processor, store a java representation of the web service description in the memory, generate an invoke message from the java representation, and transmit the invoke message to the remote web service using the output means.

16. A method for invoking a remote web service comprising:
receiving a web service description corresponding to a remote web service;
parsing the web service description;
introspecting the parsed web service description; and
invoking the remote web service.

17. The method of claim 16 wherein receiving a web service description includes:
receiving a web service description location;
generating a connection to the web service description location; and
retrieving the web service description.

18. The method of claim 17 wherein the web service description location is a URL address.

19. The method of claim 17 wherein generating a connection includes using a java language connection command.

20. The method of claim 17 wherein retrieving the web service description includes creating an input stream using ajava language command.

21. The method of claim 17 wherein the web service description is a WSDL file.

22. The method of claim 16 wherein parsing the web service description includes:
parsing the web service description for messages;
placing the messages into an internal data structure, the internal data structure residing in a memory.

23. The method of claim 22 wherein parsing the web service description includes parsing the web service description file with a parsing tool implemented in java language programming.

24. The method of claim 16 wherein introspecting the parsed web description includes:
determining the methods supported by the web service description file;
determining parameter information for each supported method; and
mapping the methods and parameters to a desired format.

25. The method of claim 24 wherein determining the methods and determining the parameter information is performed by a java API.

26. The method of claim 24 wherein the desired format is java programming format.

27. The method of claim 16 wherein invoking the remote web service includes:
generating an invoke message;
transmitting the invoke message to the remote web service.

28. The method of claim 27 wherein the invoke message is a SOAP envelope containing the remote web service URL, a name of a method to invoke, and a type and value of parameters within the method.

29. The method of claim 27 wherein the SOAP envelope is automatically created from the web service description file.

30. The method of claim 27 wherein generating the invoke message includes:
creating a SOAP envelope;
adding a body to the SOAP envelope;
adding a body element to the body; and
adding a parameter information to the body element.

31. A method for invoking a remote web service comprising:
receiving a WSDL file location;
generating a connection to the WSDL file location;
retrieving the WSDL file;
parsing the WSDL file for messages;
placing the messages into an internal data structure, the internal data structure residing in a memory;
determining the methods supported by the WSDL file, the methods corresponding to the web WSDL file messages;
determining parameter information for each supported method;
mapping the methods and parameters to a java format;
generating a SOAP envelope corresponding to the java format of the WSDL file; and
transmitting the SOAP envelope to the remote web service.
